(19) United States
(12) Patent Application Publication
(10) Pub. No.: US 2010/0023523 A1
(43) Pub. Date: Jan. 28, 2010

(54) METHOD AND APPARATUS FOR MANAGING DATA HAVING ACCESS RESTRICTION INFORMATION

(75) Inventors: Boheung CHUNG, Daejeon (KR); Kwangho BAIK, Daejeon (KR); Kiyoung KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/361,132

(22) Filed: Jan. 28, 2009

(30) Foreign Application Priority Data
Jul. 28, 2008 (KR) 10-2008-0073417

(51) Int. Cl. G06F 17/30; G06F 21/00

(52) U.S. Cl. 707/9; 726/16; 707/E17.005

(57) ABSTRACT

A method and an apparatus for managing data for providing a predetermined piece of information according to access restriction information established with regard to each piece of data are provided. The method includes: establishing the access restriction information with regard to the data when the data is stored; and determining whether an access to the data is permitted by detecting access valid time of the data from the access restriction information. The present invention establishes access valid time with regard to importance data accessed by a user and establishes a user's access denial to the importance data having access valid time exceeding the established access valid time so as to reinforce security, thereby preventing the important information from being externally leaked. Also, the present invention establishes a time limit and a cycle of each piece of important information, thereby facilitating the management of important information.

### RELATED APPLICATIONS

The present application claims priority to Korean Patent Application Serial Number 10-2008-0073417, filed on Jul. 28, 2008, the entirety of which is hereby incorporated by reference.

### BACKGROUND OF THE INVENTION

1. Field of the Invention

The present invention relates to a method and an apparatus for managing data having access restriction information. More particularly, the present invention relates to a method and an apparatus for managing data having access restriction information which controls access to important information by establishing access valid time with regard to data having important information.

This work was supported by the IT R&D program of MIC/IITA [2007-S-023-02, Development of Infringement Preventing Technology for Compound Terminal].

2. Description of the Related Art

Due to the high performance of personal computers (PCs), portable terminals, etc. and the development of ubiquitous networks, active circulation of information has been promoted. In such environment, information is greatly vulnerable to security breaches such as user's management of important information, illegal outflow of personal information, etc.

Conventional systems have managed important information in a separate and simple manner.

First, if access to important information is completely authenticated, access to the corresponding information is continuously permitted unless an additional operation of terminating access to the corresponding information is performed. In this case, another user can obtain the important information through a completely authenticated terminal. Second, it is difficult to additionally manage the important information. In this regard, the important information is data with high importance among a plurality of pieces of data. When the important information is erroneously established due to a careless management, a serious problem occurs. Third, it is not easy to discard the important information.

Therefore, a policy-based important information managing method that facilitates information management under reinforced security is needed.

### SUMMARY OF THE INVENTION

The present invention provides a method of managing data with access restriction information that establishes access valid time with regard to data having important information and permits or denies access to a predetermined piece of data based on the established access valid time.

According to an aspect of the present invention, there is provided a data managing method of providing a predetermined piece of information according to access restriction information established with regard to each piece of data, the method comprising: establishing the access restriction information with regard to the data when the data is stored; determining whether an access to the data is permitted by detecting access valid time of the data from the access restriction information; and establishing that an access to the data is permitted or restricted according to the determination result.

According to another aspect of the present invention, there is provided a data managing apparatus for providing a predetermined piece of information according to access restriction information established with regard to each piece of data, the apparatus comprising: a time limit managing unit managing access valid time of the data based on access restriction information established with regard to the data; a DB managing unit managing an access to the data based on information about the access valid time of the data detected by the time limit managing unit; and a controller establishing access restriction information with regard to the data, and generating a control instruction to control the operation of the time limit unit and the DB managing unit based on the established access restriction information.

### BRIEF DESCRIPTION OF THE DRAWINGS

FIGS. 1 and 2 are reference diagrams illustrating the structure of an apparatus for managing data with access restriction information according to an embodiment of the present invention;

FIG. 3 is a diagram illustrating access restriction information according to an embodiment of the present invention;

FIGS. 4 and 5 are reference diagrams illustrating the operation of an apparatus for managing data with access restriction information according to an embodiment of the present invention; and

FIGS. 6 and 7 are flowcharts illustrating the operation of an apparatus for managing data with access restriction information according to an embodiment of the present invention.

### DESCRIPTION OF THE PREFERRED EMBODIMENTS

The present invention will now be described more fully with reference to the accompanying drawings, in which exemplary embodiments of the invention are shown.

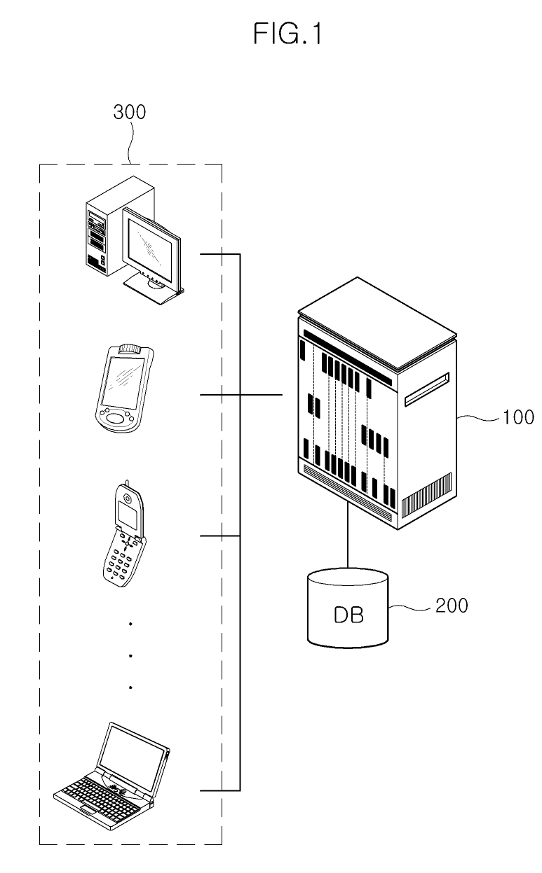

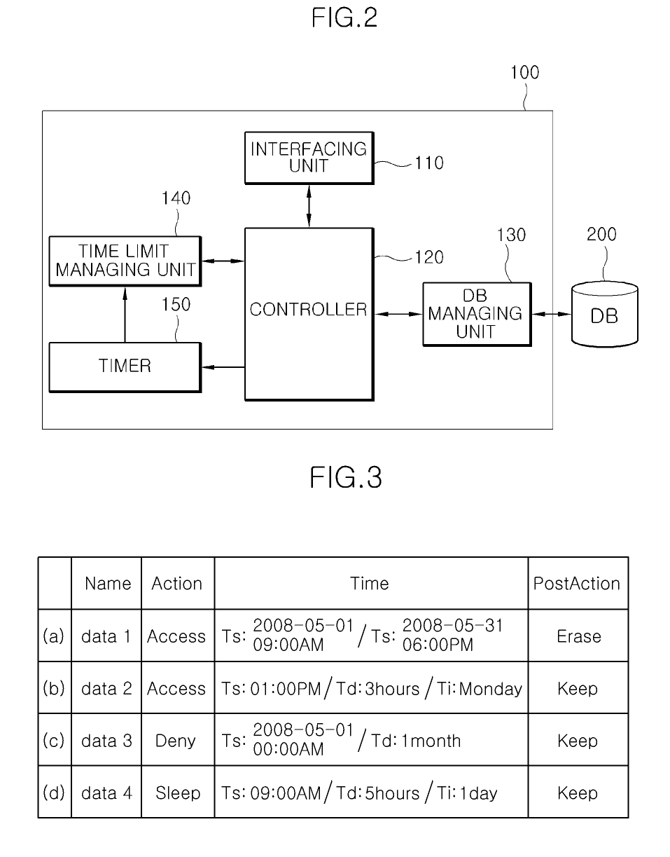

FIGS. 1 and 2 are reference diagrams illustrating the structure of an apparatus 100 for managing data with access restriction information according to an embodiment of the present invention.

Referring to FIG. 1, the data managing apparatus 100 according to the present embodiment comprises a database (hereinafter, referred to as ‘DB’) 200 for storing a predetermined piece of data. In the embodiment shown in FIG. 1, the DB 200 is separated from the data managing apparatus 100 and is interconnected to the data managing apparatus 100, but the DB 200 may be provided in the data managing apparatus 100.

The data managing apparatus 100 provides at least one connected user terminals 300 with requested data. In this regard, the user terminal 300 are connected to the data managing apparatus 100 by using wired/wireless communication methods, receives a predetermined piece of data from the data managing apparatus 100, and outputs the received data. The user terminal 300 includes at least one of a personal computer (PC), a personal digital assistant (PDA), a portable multimedia player (PMP), an MPEG audio layer-3 player (MP3P), a mobile communication terminal, and a notebook computer. The user terminal 300 comprises a module supporting a wired/wireless communication interface with the data managing apparatus 100.

FIG. 2 is a block diagram illustrating the structure of the data managing apparatus 100 according to an embodiment of the present invention. Referring to FIG. 2, the data managing apparatus 100 comprises an interfacing unit 110, a controller 120, a DB managing unit 130, a time limit managing unit 140, and a timer 150.

The interfacing unit 110 comprises a module for communicating with the at least one user terminals 300 to allow the data managing apparatus 100 and the at least one user terminals 300 to transmit/receive data therebetween.

The DB managing unit 130 is connected to the DB 200, and manages data stored in the DB 200 and access restriction information established for each piece of the data. The access restriction information includes at least one of access valid time information about access permission establishment status, and data processing status with regard to the data. The access valid time includes at least one of access permission start time, access permission end time, access permission continuation time, and an access permission cycle with regard to the data.

The time limit managing unit 140 receives time information from the timer 150 that is internally or externally disposed. The time limit managing unit 140 receives the access restriction information of the data managed by the DB managing unit 130, compares the access restriction information with the time information provided by the timer 150, and manages access time limit information with regard to each piece of the data stored in the DB 200.

The controller 120 establishes access restriction information with regard to data generated according to an internal operation and data received from the outside, and stores the established access restriction information in the DB 200.

The controller 120 generates a control instruction used to control the operation of the time limit managing unit 140 and the DB managing unit 130. In more detail, the controller 120 provides the DB managing unit 130 with the access restriction information with regard to the corresponding data when the data is stored in the DB 200. The DB managing unit 130 establishes an access status with regard to the corresponding data based on the access restriction information provided by the controller 120. Meanwhile, the controller 120 also provides the time limit managing unit 140 with the access restriction information with regard to the corresponding data when the data is stored in the DB 200.

Therefore, the time limit managing unit 140 detects access valid time with regard to the corresponding data based on the access restriction information provided by the controller 120. The time limit managing unit 140 confirms whether the data is in the access valid time with regard to the corresponding data and transmits the confirmed result to the controller 120. The controller 120 transmits signal confirming whether the data is in the access valid time to the DB managing unit 130. The DB managing unit 130 changes an access status with regard to the data stored in the DB 200 in real time based on the signal received from the controller 120.

If the user terminal 300 accesses the data managing apparatus 100 and requests a predetermined piece of data for the data managing apparatus 100, the controller 120 detects the requested data from the DB 200 and provides the user terminal 300 with the detected data. If access permission time of the requested data is not granted, the controller 120 generates a message informing that the DB managing unit 130 denies access to the corresponding data and transmits the message to the user terminal 300.

FIGS. 3 to 5 are reference diagrams illustrating the operation of an apparatus for managing data with access restriction information according to an embodiment of the present invention.

FIG. 3 is a diagram illustrating access restriction information of each piece of data according to an embodiment of the present invention. Referring to FIG. 3, the access restriction information of each piece of data is classified into a data name “Name”, an access permission establishment status “Action”, access valid time “Time”, and a data processing status “PostAction”.

The access permission establishment status is an item for establishing whether access to current data is permitted, and may be classified into an access permission “Access”, an access deny “Deny”, an access restriction “Sleep”, an access activation “Wake-up”, etc. The access permission establishment status can be automatically selected and established according to whether data reaches the access valid time, and may be established according to a manually input control instruction.

The access valid time is an item for establishing time permitted for access to the data, and can be selectively established from access permission start time “Ts”, access permission end time “Te”, access permission continuation time “Td”, and an access permission cycle “Ti” with regard to the data.

The data processing status is an item for establishing postprocessed data when the access valid time expires, and can be selectively established from a keeping “Keep” and an erasure “Erase”.

In more detail, referring to FIG. 3(a) illustrating access restriction information with regard to “data 1”, a current access permission status is “Access” and an access permission is established, and access valid time is ‘Ts:May 01, 2008 09:00 AM/Te:May 31, 2003 06:00 PM’ and access valid time of May is established so that access is valid in May. In this regard, a data processing status of the data 1 is “Erase” and the data 1 is discarded after the access valid time expires.

Meanwhile, referring to FIG. 3(b) illustrating access restriction information with regard to “data 2”, a current access permission status is “Access” and an access permission is established, and access valid time is ‘Ts:1:00 PM/Td:3 hours/Ti:Monday’ and access valid time between 1 PM and 3 PM every Monday is established. In this regard, a data processing status of the data 2 is “Keep” and the data 2 is continuously kept after the access valid time expires. The data 2 having the expired access valid time is kept in the DB 200 after an access denial is established.

Meanwhile, referring to FIG. 3(c) illustrating access restriction information with regard to “data 3”, a current access permission status is “Deny” and an access denial is established, and access valid time is ‘Ts:Apr. 15, 2008 00:00 AM/Td: 1 month’ and access valid time of one month from Apr. 15, 2008 is established. In this case, the access valid time expires and the access denial is established or a manager can forcibly establish the access denial before the access valid time expires. A data processing status of the data 3 is “Keep” and the data 3 is continuously kept after the access valid time expires.

Meanwhile, referring to FIG. 3(d) illustrating access restriction information with regard to “data 4”, a current access permission status is “Sleep” and temporal access restriction is established, and access valid time is ‘Ts:9:00 AM/Td:5 hours/Ti:1 day’ and access valid time between 9 AM and 5 PM every morning is established. In this regard, in the access permission status “Sleep”, access to the data 4 is temporally restricted within the access valid time. The access permission status is changed to “wake-up” so that an access restriction establishment is canceled and the access to the data 4 is permitted again. A data processing status of the data 4 is “Keep” and the data 4 is continuously kept after the access valid time expires.

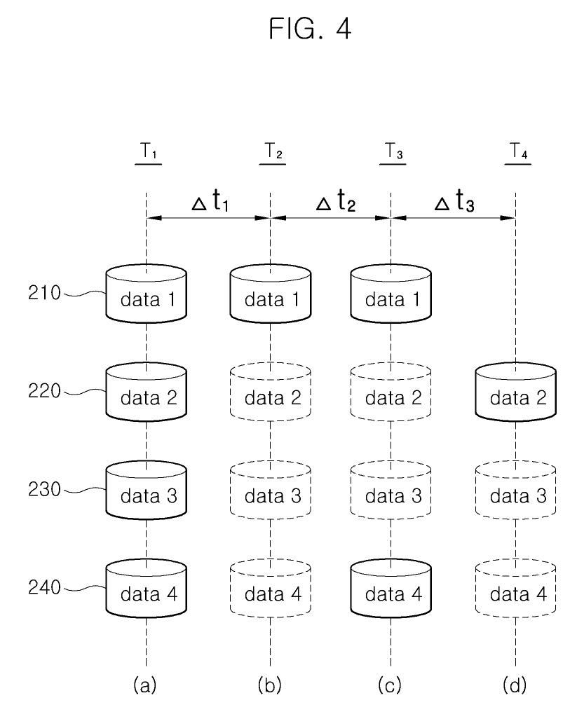

FIG. 4 is a diagram of data statuses with regard to time based on the embodiment shown in FIG. 3. FIGS. 4(a) to 4(d) illustrate data access permission statuses based on access restriction information established with regard to data 1 210, data 2 220, data 3 230, and data 4 240, respectively, at T1, T2, T3, and T4 times according to time flow.

T1, T2, T3, and T4 are optionally selected times based on the access valid time shown in FIG. 3, and are established as ‘May 12, 2008 1:00 PM’, ‘May 15, 2008 4:00 PM’, ‘May 17, 2008 11:00 AM’, and ‘May 19, 2008 3:00 PM’, respectively. In this regard, data to which access is permitted is indicated by a solid line, and data to which access is restricted or denied is indicated by a dotted line.

Referring to FIG. 4(a), since the data 1 210, data 2 220, data 3 230, and data 4 240 correspond to all access valid times at the T1 time, it is confirmed that an access permission is established.

Referring to FIG. 4(b), since the data 1 210 only corresponds to the access valid time at the T2 time after t1 time elapses from the T1 time, it is confirmed that the access permission with regard to the data 1 210 is established, and the data 2 220, data 3 230, and data 4 240 do not correspond to the access valid time at the T2 time, which confirms that an access restriction with regard to the data 2 220, data 3 230, and data 4 240 is established. Since the access valid time with regard to the data 3 230 expires, the access denial with regard to the data 3 230 is established and then the data 3 230 is kept in the DB 200 according to the data processing establishment.

Referring to FIG. 4(c), since the data 1 210 and the data 4 240 correspond to the access valid time at the T3 time after t2 time elapses from the T2 time, which confirms that the access permission with regard to the data 1 210 and the data 4 240 is established, and the data 2 220 and the data 3 230 do not correspond to the access valid time at the T3 time, it is confirmed that the access restriction with regard to the data 2 220 and the data 3 230 is established.

Referring to FIG. 4(d), since the data 2 220 only corresponds to the access valid time at the T4 time after t3 time elapses from the T3 time, which confirms that the access permission with regard to the data 2 220 is established, and the data 3 230 and the data 4 240 do not correspond to the access valid time at the T4 time, it is confirmed that the access restriction with regard to the data 3 230 and the data 4 240 is established. Since the access valid time with regard to the data 1 210 expires, the data 1 210 is discarded according to the data processing establishment.

When data with access restriction information is managed according to the present invention, an access to specific data is permitted at a specific time, which facilitates the management of data having important information, and, more particularly, a cycle is established with regard to access valid time, which facilitates a repetitive management of data. For example, when a specific company holds a periodic seminar every Monday, an access to data is permitted during the seminar, and access to the data is denied except during the seminar. Also, even though the data does not necessarily have important information, an access to data is denied before school, and the data is provided to spend a predetermined leisure time after school.

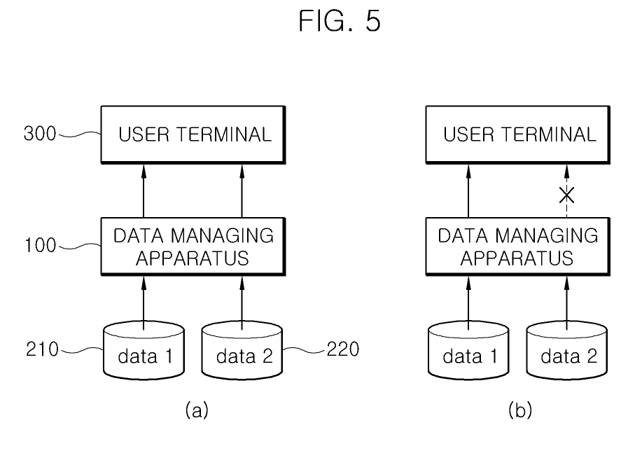

FIG. 5 is a diagram illustrating the operation of the data managing apparatus 100 based on the embodiment shown in FIG. 4. Referring to FIG. 5(a), the data 1 210 and the data 2 220 are provided to the user terminal 300 with reference to FIG. 4(a). Referring to FIG. 5(b), the data 1 210 is provided to the user terminal 300 with reference to FIG. 4(b).

In more detail, referring to FIG. 5(a), since an access permission with regard to the data 1 210 and the data 2 220 is established at T1 time, the data managing apparatus 100 provides the user terminal 300 with the data 1 210 and the data 2 220.

Meanwhile, referring to FIG. 5(b), since an access restriction with regard to the data 2 220 is established at T2 time, the data managing apparatus 100 provides the at least one user terminals 300 with the data 1 210. The data managing apparatus 100 generates a message informing that the access restriction with regard to the data 2 220 is established and transmits the message to the user terminal 300.

The operation of the present embodiment will now be described.

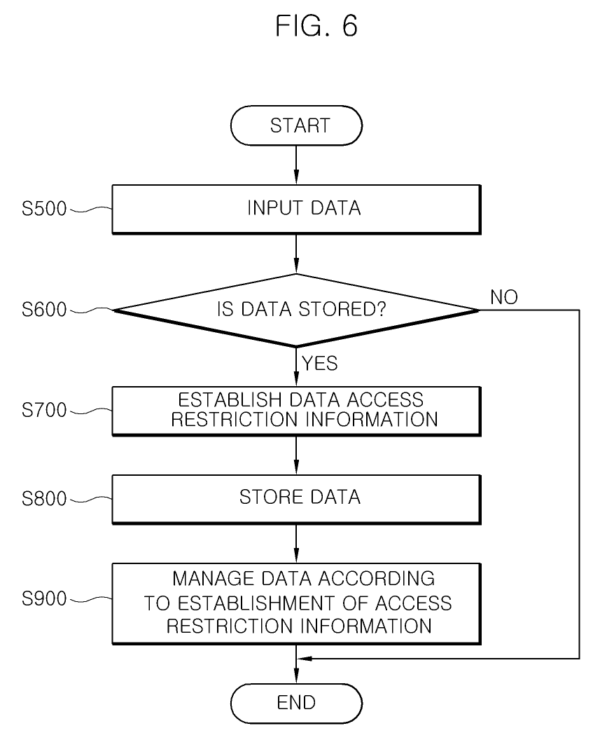

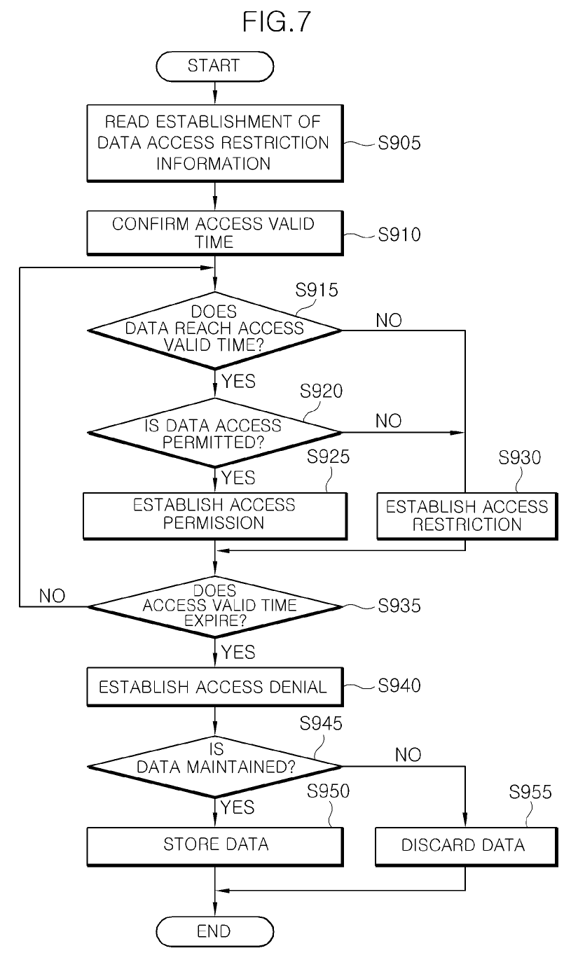

FIGS. 6 and 7 are flowcharts illustrating the operation of an apparatus for managing data with access restriction information according to an embodiment of the present invention.

Referring to FIG. 6, if the data is received from the outside through the interfacing unit 110 or is manually input by a manager (step 500), the controller 120 establishes the access restriction information of the data according to the condition input by the manager (step 700) when the input data is stored (step 600), and the data and the corresponding access restriction information are stored in the DB 200 (step 800). The controller 120 provides the time limit managing unit 140 and the DB managing unit 130 with the access restriction information of the data, and controls the time limit managing unit 140 and the DB managing unit 130 to manage the data based on the access restriction information (step 900).

Meanwhile, FIG. 7 is a detailed flowchart of step 900. Referring to FIG. 7, the time limit managing unit 140 reads the access restriction information provided by the controller 120 (step 905), and confirms access valid time of the corresponding data (step 910). The time limit managing unit 140 confirms whether the data reaches the access valid time based on current time information provided by the internal or external timer 150, and informs the controller 120 of the confirmation.

The DB managing unit 130 receives a signal confirming whether the data reaches the access valid time from the controller 120. If the data reaches the access valid time (step 915), the DB managing unit 130 automatically determines that an access to the corresponding data is permitted (step 920), and establishes an access permission to the corresponding data (step 925).

Meanwhile, if an access restriction instruction such as “Sleep” is input according to a manual operation, even though the data reaches the access valid time, the DB managing unit 130 determines that the access to the corresponding data is not permitted (step 920), and establishes an access restriction to the corresponding data (step 930). In this case, if an access restriction establishment cancellation instruction such as “Wake-up” is input according to the manual operation, the access restriction established with regard to the corresponding data is cancelled, so that the access permission to the corresponding data can be activated (step 920 and step 925). An access restriction establishment cancellation operation can be possible within the access valid time. To the contrary, if the data does not reach the access valid time (step 915), the DB managing unit 130 automatically establishes that the access to the corresponding data is restricted (step 930).

The DB managing unit 130 detects if access valid time of specific data expires (step 935). That is, the DB managing unit 130 detects whether specific data exceeds access permission end time among the access valid time. If the DB managing unit 130 detects that the access permission end time of specific data exceeds, the DB managing unit 130 establishes that an access to the corresponding data is denied (step 940), keeps the data with access denied according to a data processing status in the DB 200, or discards the data by deleting the data (steps 945-955).

In this regard, the controller 120 outputs a message confirming the data processing status with regard to the data having access valid time expired according to the establishment, thereby reconfirming whether to keep or discard the data from the manager.

The present invention establishes access valid time with regard to importance data accessed by a user and establishes a user's access denial to the importance data having access valid time exceeding the established access valid time so as to reinforce security, thereby preventing the important information from being externally leaked. Also, the present invention establishes a time limit and a cycle of each piece of important information, thereby facilitating the management of important information.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A data managing method of providing a predetermined piece of information according to access restriction information established with regard to each piece of data, the method comprising:
establishing the access restriction information with regard to the data when the data is stored;
determining whether an access to the data is permitted by detecting access valid time of the data from the access restriction information; and
establishing that an access to the data is permitted or restricted according to the determination result.

2. The method of claim 1, wherein the access restriction information comprises at least one of access valid time, information about access permission establishment status and data processing status with regard to the data.

3. The method of claim 1, wherein the access valid time comprises at least one of access permission starting time and an access permission cycle with regard to the data.

4. The method of claim 1, wherein the access valid time comprises at least one of the access permission stating time, access permission ending time, and access permission continuation time with regard to the data.

5. The method of claim 1, wherein it is confirmed whether the data reaches the access valid time, and, when the data reaches the access valid time, it is established that the access to the data is permitted.

6. The method of claim 5, further comprising:
when an additional access restriction instruction is input in a status where the data reaches the access valid time, establishing that the access to the data is restricted.

7. The method of claim 6, further comprising:
when it is established that the access to the data is restricted in the status where the data reaches the access valid time, cancelling the establishment that the access to the data is restricted if an additional access restriction cancellation instruction is input.

8. The method of claim 1, further comprising:
when it is confirmed whether the access valid time of the data expires, and the access valid time of the data expires, establishing that the access to the data is denied.

9. The method of claim 8, further comprising:
when the access valid time of the data expires, confirming whether to keep the data and keeping or discarding the data.

10. A data managing apparatus for providing a predetermined piece of information according to access restriction information established with regard to each piece of data, the apparatus comprising:
a time limit managing unit managing access valid time of the data based on access restriction information established with regard to the data;
a DB managing unit managing an access to the data based on information about the access valid time of the data detected by the time limit managing unit; and
a controller establishing access restriction information with regard to the data, and generating a control instruction to control the operation of the time limit managing unit and the DB managing unit based on the established access restriction information.

11. The apparatus of claim 10, wherein the access valid time comprises at least one of an access permission starting time and an access permission cycle with regard to the data.

12. The apparatus of claim 10, wherein the time limit managing unit detects current time information from an internal or external timer, and compares the detected current time information with the access valid time of the data.

13. The apparatus of claim 10, wherein the DB managing unit establishes access permission with regard to data that reaches the access valid time, and, if the data does not reach the access valid time, establishes an access restriction with regard to the data.

14. The apparatus of claim 10, wherein the DB managing unit establishes an access denial with regard to data having the access valid time expired.

15. The apparatus of claim 14, wherein the DB managing unit confirms whether to keep the data having the access valid time expired, and keeps or discards the data.

16. The apparatus of claim 10, further comprising:
a DB storing the data and access restriction information corresponding to the data.
